(19) United States
(12) Patent Application Publication
(10) Pub. No.: US 2002/0088214 A1
(43) Pub. Date: Jul. 11, 2002

(54) Filter system for small engines

(76) Inventor: Walter J. Sherwood, Troy, NY (US)

Correspondence Address: HOFFMAN WARNICK & D'ALESSANDRO, LLC, 3 E-COMM SQUARE, ALBANY, NY, 12207

(21) Appl. No.: 09/754,954

(22) Filed: Jan. 5, 2001

(51) Int. Cl. B01D 46/00

(52) U.S. Cl. 55/486; 55/495; 55/523

(57) ABSTRACT

A filter system for removing pollutants such as soot and unburned hydrocarbons from exhaust of an exhaust producing device. The system includes: a housing including an opening; a replaceable filter section sized to fit through the opening, the filter section including a reinforcing ceramic coating. The housing is attachable to an exhaust port or muffler of the exhaust producing device to remove pollutants.

### BACKGROUND OF THE INVENTION

1. Technical Field

The present invention relates generally to exhaust filtering, and, in particular, to a filter system for small engines.

2. Related Art

Growing concern about pollution generated by small engines such as those on lawn mowers has produced a need for a simple method for removal of pollutants from the exhaust of such engines. Additionally, the profusion of personal water craft and snowmobiles has created concern for emissions from those vehicles as well.

Currently, there are limited examples of exhaust filters specifically designed for small or recreational engines. Small engines are defined in this case as engines with less than 1000 cubic centimeters of displacement or under 25 horsepower in output and typically drive lawn mowers, lawn tractors, generators, weed trimmers, etc. Recreational engines are those engines typically below 1700 cubic centimeters in displacement that power motorcycles, jet-skis, snowmobiles, and all terrain vehicles (ATVs). Both small and recreational engines can be either two-stroke (emit much more smoke and hydrocarbons) or the cleaner four-stroke engines. The two-stroke engines are much more powerful on a weight basis but generate more emissions.

In view of the foregoing, there is a need in the art for a filter system for small engines.

### SUMMARY OF THE INVENTION

In a first aspect of the invention is provided a filtration apparatus for treatment of exhaust from an exhaust producing device, the apparatus comprising: a housing; and a particulate filter section positioned within the housing, the particulate filter section being coated with a ceramic.

In a second aspect of the invention is provided a filter system for removing pollutants from exhaust of an exhaust producing device, the system comprising: a housing including an opening; a replaceable filter section sized to fit through the opening, the filter section including a reinforcing ceramic coating; and wherein the housing is attachable to an exhaust output of the exhaust producing device.

In a third aspect is provided a system comprising: an engine of under 65 horsepower and having an exhaust output; a housing coupled to the exhaust output and including an opening; a replaceable filter section positioned within the housing and sized to fit through the opening, the filter section including: a filter media made of material chosen from the group comprising: ceramic fiber, glass fiber paper, felt, cloth, mat and monolithic ceramic honeycomb structures; and a reinforcing ceramic coating made of material chosen from the group comprising: silicon carbide, silicon nitride, silicon oxycarbide, aluminosilicate, silica and aluminum oxide.

Exhaust gas filtered by the invention is cleaned of smoke particles, and condensable vapors. The invention also functions as a protective guard or heat shield over a hot muffler to protect the vehicle and its operators. The size of the filter system can be tailored to the engine size and type to optimize performance.

### BRIEF DESCRIPTION OF THE DRAWINGS

The preferred embodiments of this invention will be described in detail, with reference to the following figures, wherein like designations denote like elements, and wherein:

FIG. 1 is a side view of a small engine and filter system in accordance with the invention;

FIG. 2 is a perspective rear view of the filter system of FIG. 1;

FIG. 3 is a perspective view of the filter system of FIG. 2 with an open hinged gate side;

FIG. 4 is a perspective view of a filter media;

FIG. 5 is a cross-sectional view of a multi-layer pleated parallel flow filter media; and

FIG. 6 is a cross-sectional view of a multi-layer pleated/corrugated cross-flow filter media.

### DETAILED DESCRIPTION OF THE PREFERRED EMBODIMENTS

Although certain preferred embodiments of the present invention will be shown and described in detail, it should be understood that various changes and modifications may be made without departing from the scope of the appended claims. The scope of the present invention will in no way be limited to the number of constituting components, the materials thereof, shapes thereof, the relative arrangement thereof, etc., which are disclosed simply as an example of the preferred embodiment.

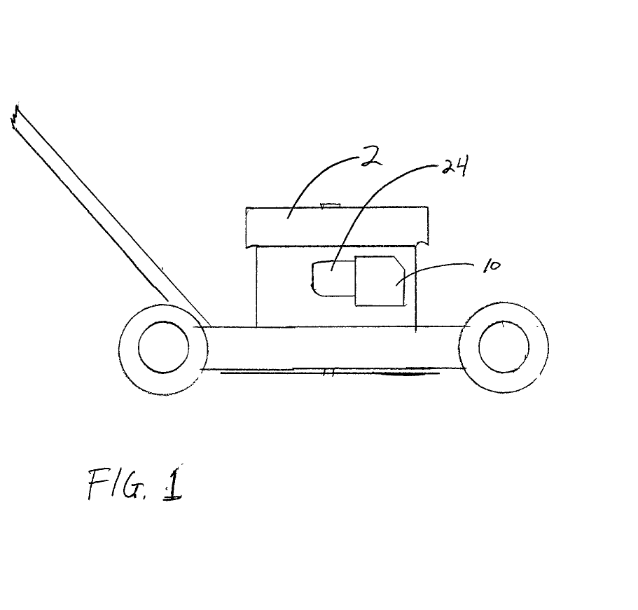

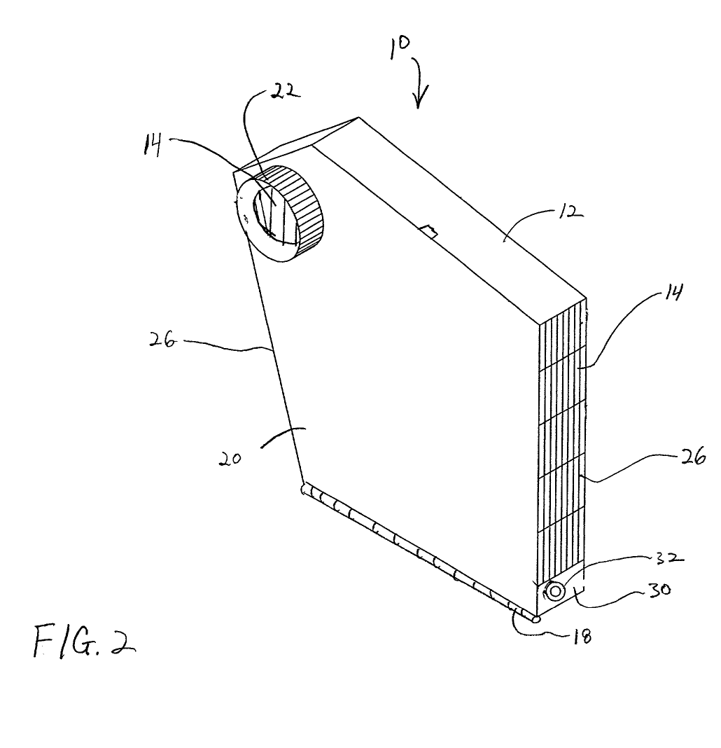

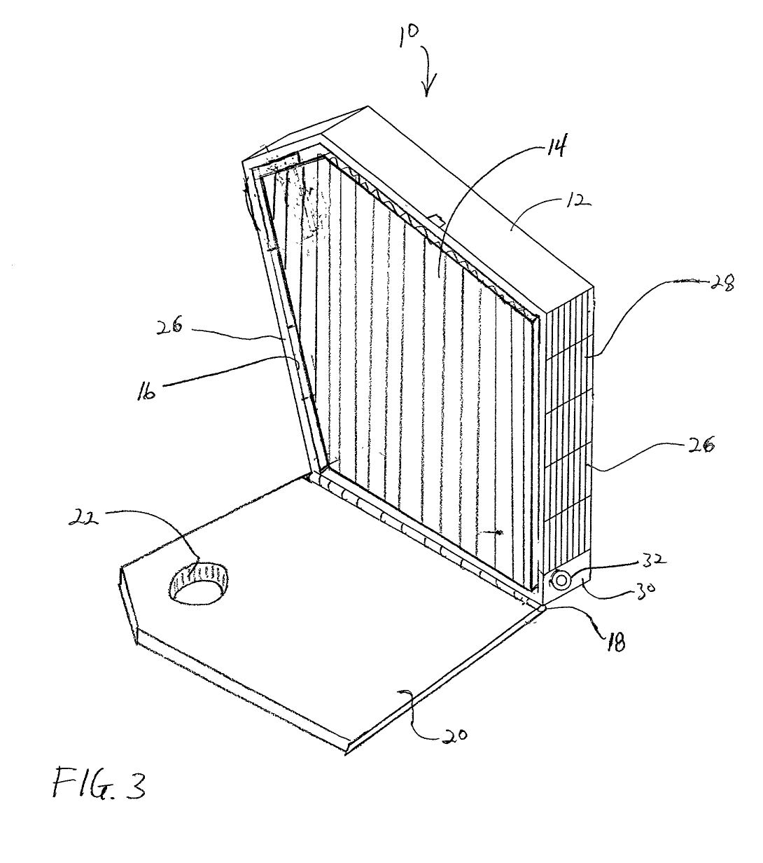

Referring to the FIGS. 1-3, a filter system or filtration apparatus 10 for treatment of exhaust from an exhaust producing device such as engine 2 is shown. Filter system 10 preferably finds advantage with small engines under 65 horsepower and more preferably with small engines under 25 horsepower. These engines typically have less than 1700 cubic centimeters of displacement and less than 1000 cubic centimeters in displacement, respectively. As shown in FIGS. 2-3, filter system 10 includes a housing 12 and a particulate filter section 14 positioned within housing 12.

Housing 12 includes an opening 16 provided, for example, by a hinged 18 gate side 20. Opening 16 is sized so filter section 14 can be positioned within housing 12, and allows for replacement of filter section 14 for, e.g., disposal. While opening 16 has been illustrated as a hinged 18 opening of housing 12, it should be recognized that any other manner of providing an opening to the interior of housing 12 is considered within the scope of the invention. Housing 12 also preferably includes a port 22 adapted to be mounted to an exhaust output 24, e.g., exhaust port or muffler (FIG. 1) of engine 2. Accordingly, port 22 can be round or any other configuration to attach to exhaust output 24 of engine 2. A clamping system (not shown) may be used to attach filter system 10 to exhaust output of engine 2.

One or more sides 26 of housing 12 include a row of parallel exhaust exits 28. The shape of exits 28 are a function of the design of the filter media. A lowermost edge of housing 12 could also have a reservoir 30 to collect any oil vapor condensation trapped by filter section 14, which would be drained by removing a drain plug 32 at the bottom of reservoir 30. Housing 12 is preferably made from metal, ceramic or high temperature plastic.

Turning to the particulate filter section, filter section 14 is sized to fit through opening 16 and be positioned in housing 12 such that exhaust may be forced through filter section 14. Particulate filter section 14 is preferably made of ceramic fiber, glass fiber paper, ceramic or glass felt, ceramic or glass cloth, ceramic or glass mat or monolithic ceramic honeycomb structures.

Referring to FIG. 4, one type of filter media could include a number of stacked sheets of ceramic paper 34 separated by thin strips of ceramic 36 to provide space for gas to enter between the sheets. Edges 38 would be blocked (as indicated by shading) to force the gas through one of the sheets and allow the gas to exit. For example, a typical filter would have the gas enter one edge 37, e.g., the top edge as indicated by arrows, and have the respective bottom edge 38B and side edges 38S blocked. The adjacent channels, e.g., channel 39, would have their top edge 38T and bottom edge blocked, but the corresponding sides of the channels would be left open. The exhaust entering edge 37 would then be forced to pass through the filter media and exit side edges of channel 39. The cleaned gas would exit the filter through one or both side edges.

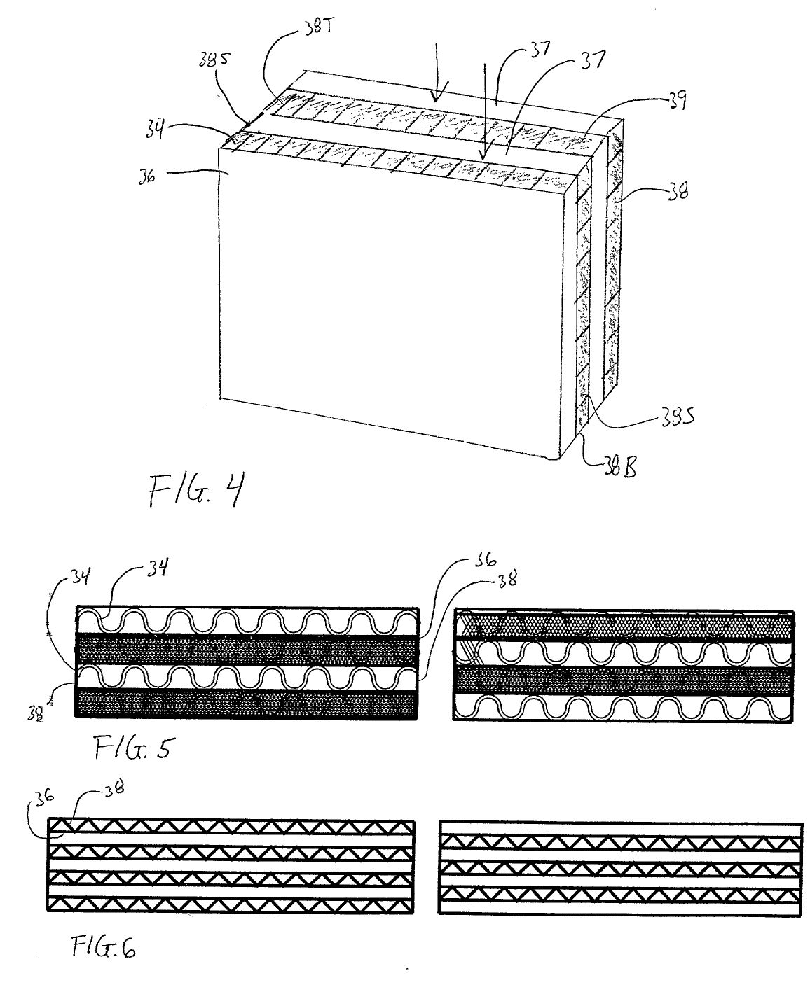

As shown in FIGS. 5-6, other examples of the filter media design include a “U” pleated or corrugated (FIG. 5) or “V” pleated (FIG. 6) single or multiple layer elements. Single layers of material may be advantageous for small, relatively clean engines, while multiple layer elements may be advantageous for larger polluting engines such as two stroke systems. In most cases, the filter should last an entire season before needing replacement.

In accordance with a preferred embodiment of the invention, filter section 14 is coated with a reinforcing ceramic chosen from the group comprising: silicon carbide, silicon nitride, silicon oxycarbide, aluminosilicate, silica, and aluminum oxide. Further, the ceramic is preferably formed by a pyrolysis of a pre-ceramic polymer such as that disclosed in U.S. Pat. No. 5,153,295 to Whitmarsh et al. The ceramic coating provides a hardened, stiffened and more durable filter.

Exhaust gas filtered by filter system 10 is cleaned of pollutants such as smoke particles and condensable vapors. System 10 also functions as a protective guard or heat shield over a hot exhaust port 24, e.g., muffler, of engine 2 to protect operators. The size of filter system 10 can be tailored to the engine size and type to optimize performance.

Filter system 10 in accordance with the invention finds application with a variety of exhaust producing devices. For instance, exhaust producing device may be: an internal combustion engine (either four or two stroke) powering a lawn mower, weed trimmer, generator, all terrain vehicle, tractor, boat, jet ski, snowmobile, or other device. Additionally, the filter system can be applied to: a stove, a grill, a fireplace or wood stove chimney or exhaust stack, an asphalt paving machine to collect the harmful vapors and gases from the asphalt in the hopper. The relatively large surface area of filter system 10 and the size of housing 12 cause the exhaust gas to cool and also insulates a user from the hot exhaust. Hence, filter system 10 acts as a muffler and a heat shield.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and the scope of the invention as defined in the following claims.

1. A filtration apparatus for treatment of exhaust from an exhaust producing device, the apparatus comprising:
a housing; and
a particulate filter section positioned within the housing, the particulate filter section being coated with a ceramic.

2. The apparatus of claim 1, wherein the ceramic is chosen from the group consisting of:
silicon carbide, silicon nitride, silicon oxycarbide, aluminosilicate, silica, and aluminum oxide.

3. The apparatus of claim 2, wherein the ceramic is formed by a pyrolysis of a pre-ceramic polymer.

4. The apparatus of claim 1, wherein the housing is made of a material chosen from the group consisting of: metal, ceramic and high temperature plastic.

5. The apparatus of claim 1, wherein the filter section is made of a material chosen from the group consisting of: ceramic fiber, glass fiber paper, felt, cloth, mat and monolithic ceramic honeycomb structures.

6. The apparatus of claim 1, wherein the filter section is regeneratable and reusable.

7. The apparatus of claim 1, wherein the filter section is disposable.

8. The apparatus of claim 1, wherein the exhaust producing device is an engine of under 65 horsepower.

9. The apparatus of claim 1, wherein the exhaust producing device is an engine of under 25 horsepower.

10. A filter system for removing pollutants from exhaust of an exhaust producing device, the system comprising:
a housing including an opening;
a replaceable filter section sized to fit through the opening, the filter section including a reinforcing ceramic coating; and
wherein the housing is attachable to an exhaust output of the exhaust producing device.

11. The system of claim 10, wherein the ceramic is chosen from the group consisting of: silicon carbide, silicon nitride, silicon oxycarbide, aluminosilicate, silica, and aluminum oxide.

12. The apparatus of claim 11, wherein the ceramic is formed by a pyrolysis of a pre-ceramic polymer.

13. The system of claim 10, wherein the housing is made of a material chosen from the group consisting: metal, ceramic and high temperature plastic.

14. The system of claim 10, wherein the filter section is made of a material chosen from the group consisting: ceramic fiber, glass fiber paper, ceramic felt, glass felt, ceramic cloth, glass cloth, ceramic mat, glass mat and monolithic ceramic honeycomb structures.

15. The system of claim 10, wherein the filter section is regeneratable and reusable.

16. The system of claim 10, wherein the filter system is disposable.

17. The system of claim 10, wherein the exhaust producing device is an engine of under 65 horsepower.

18. The system of claim 10, wherein the exhaust producing device is an engine of under 25 horsepower.

19. A system comprising:
an engine of under 65 horsepower and having an exhaust output;
a housing coupled to the exhaust output and including an opening;
a replaceable filter section positioned within the housing and sized to fit through the opening, the filter section including:
a filter media made of material chosen from the group consisting of: ceramic fiber, glass fiber paper, felt, cloth, mat and monolithic ceramic honeycomb structures; and
a reinforcing ceramic coating made of material chosen from the group consisting: silicon carbide, silicon nitride, silicon oxycarbide, aluminosilicate, silica and aluminum oxide.

20. The system of claim 19, wherein the ceramic coating is formed by a pyrolysis of a pre-ceramic polymer.
